(19) United States
(12) Patent Application Publication
(10) Pub. No.: US 2006/0078411 A1
(43) Pub. Date: Apr. 13, 2006

(54) Mountable refuse container

(76) Inventor: Maria Casab, Commerce, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/244,844

(22) Filed: Oct. 6, 2005

Related U.S. Application Data
(60) Provisional application No. 60/617,388, filed on Oct. 8, 2004.

(51) Int. Cl. B65F 3/02

(52) U.S. Cl. 414/408

(57) ABSTRACT

An anti-spill container is provided. An anti-spill container in accordance with the present invention comprises a receptacle having an open end and closed end, wherein the open end and closed end define a cavity therein. The container further includes a lid detachably coupled to the receptacle wherein the lid comprises a frame and a flexible portion disposed within the frame. The anti-spill container still further includes a mounting mechanism operative to mount the container to a surface.

### CROSS REFERENCE TO RELATED APPLICATIONS

This application claims the benefit of U.S. Provisional Patent Application Ser. No. 60/617,388 filed Oct. 8, 2004, which is hereby incorporated by reference in its entirety.

### BACKGROUND OF THE INVENTION

1. Technical Field

This invention relates generally to an anti-spill container. More particularly, the invention relates to a mountable anti-spill container for collecting refuse.

2. Discussion of the Related Art

The ability to contain and collect refuse in an anti-spill container is critical to providing a sanitary and healthy environment. Containing waste or other refuse in a spill proof container prevents the spread of germs and various other disease causing bacteria that are proliferated by the exposure of refuse to the environment, as well as provides for a generally cleaner and more orderly environment. Therefore, it is necessary to provide a container that aids in the containment of waste and other refuse.

Trash cans or other refuse containment receptacles have been developed to aid in the collection and disposal of refuse. There are many different types of refuse containers, including those that range in size from small to large, and those that are provided with lids and those without. Each of the refuse containers provide a means for the disposal of refuse, but typically require an individual to either open the container to place additional refuse within, or are open to the environment. Accordingly, the refuse contained within the container is exposed to the open air, and may spill into the surrounding area if the container is knocked over or is overflowing with refuse. There is a need to provide a refuse container that provides an isolated environment for the collection of refuse, thereby preventing the spreading of germs. Furthermore, with the large amount of refuse that is produced every day, there is an increasing need to have easily accessible refuse containers for use by the public.

### SUMMARY OF THE INVENTION

An anti-spill container is provided. An anti-spill container in accordance with the present invention comprises a receptacle having an open end and closed end, wherein the open end and closed end define a cavity therein. The container further includes a lid detachably coupled to the receptacle wherein the lid comprises a frame and a flexible portion disposed within the frame. The anti-spill container still further includes a mounting mechanism operative to mount the container to a surface.

These and other features and objects of this invention will become apparent to one skilled in the art from the following detailed description and the accompanying drawings illustrating features of this invention by way of example.

### DESCRIPTION OF DRAWINGS

FIG. 1 is a perspective view of a container in accordance with one preferred embodiment of the present invention.

FIG. 2 is an exploded view of the container illustrated in FIG. 1 in accordance with one preferred embodiment of the present invention.

FIG. 3a is a top plan view of a first piece of a lid portion of the container illustrated in FIGS. 1 and 2 in accordance with one preferred embodiment of the present invention.

FIG. 3b is a bottom plan view of the first piece of the lid portion illustrated in FIG. 3a in accordance with one preferred embodiment of the present invention.

FIG. 3c is a cross sectional view of a portion of the first piece of the lid portion shown in FIGS. 3a and 3b taken along the lines 3c-3c in FIG. 3a, in accordance with one preferred embodiment of the present invention.

FIG. 4a is side elevational view of a second piece of the lid of the container illustrated in FIGS. 1 and 2 in accordance with one preferred embodiment of the present invention.

FIG. 4b is a sectional view of a portion of the second piece of the lid portion illustrated in FIG. 4a in accordance with one preferred embodiment of the present invention.

FIG. 4c is cross sectional view of a portion of the second piece of the lid portion illustrated in FIG. 4a taken along the lines 4c-4c in FIG. 4b in accordance with one preferred embodiment of the present invention.

FIG. 5 is a side elevational view of the lid portion of the container illustrated in FIG. 1 in a disassembled state in accordance with one preferred embodiment of the present invention.

FIG. 6 is a sectional view of a portion of the lid portion of the assembled container illustrated in FIG. 1 in accordance with one preferred embodiment of the present invention.

FIG. 7 is a side elevational view of the lid portion of the assembled container illustrated in FIG. 1 in accordance with one preferred embodiment of the present invention.

FIG. 8 is a front view of the container illustrated in FIG. 1 when the container is mounted in accordance with one preferred embodiment of the present invention.

FIG. 9 is a perspective sectional view of the lid portion of the container illustrated in FIG. 1 showing an alternate embodiment of the mounting mechanism for the container in accordance with an alternate preferred embodiment of the present invention.

### DETAILED DESCRIPTION OF THE INVENTION

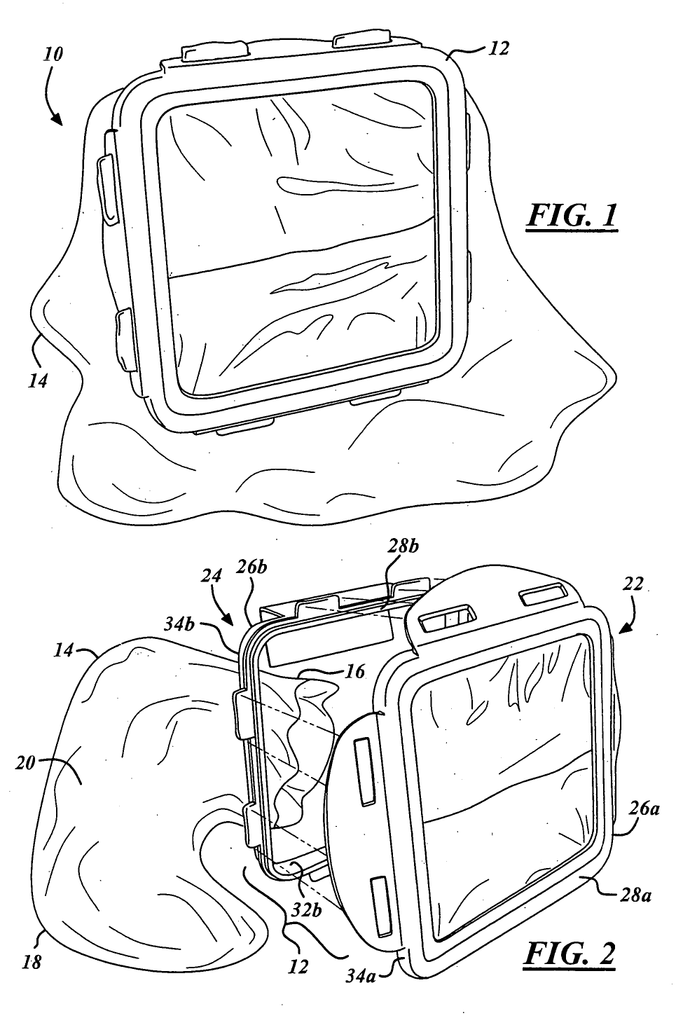

Referring now to the drawings wherein like reference numerals are used to identify identical components in the various views, FIG. 1 shows a first exemplary embodiment of a refuse container 10. It should be noted that while the present inventive container 10 will be described in detail as a refuse container, the inventive container is not limited to such an application. Rather, container 10 may be used in a variety of applications wherein it is desirable to retain given items in a mountable anti-spill container. Such applications include, but are not limited to, household and office applications, as well as for the containment and retention of various food items, for example.

With reference to FIGS. 1 and 2, container 10 of the present invention includes a lid 12 that is detachably coupled with a receptacle 14. Receptacle 14 has an open end 16 and a closed end 18, thereby providing a cavity 20 for the collection of refuse or other materials therein (best shown in the exploded view in FIG. 2). Receptacle 14 may have a bag-like configuration and can be provided in a variety of shapes and sizes (i.e., small and large garbage bags, grocery and other retail store bags, zip-loc bags, etc.). Similarly, receptacle 14 may be made of a limitless number of materials (i.e., plastic, fabric, paper, and the like), and may be disposable and replaceable. In one preferred embodiment, receptacle 14 is formed of plastic and is disposable such that it may be replaced with a replacement receptacle of the same or similar physical attributes should the original receptacle become filled, for example. However, in an alternate preferred embodiment, the same receptacle may be re-used after its contents have been discarded. Moreover, receptacle 14 may be provided in any type of configuration that allows for lid 12 to be readily attached to receptacle 14, thereby providing cavity 20 for receiving refuse.

In one preferred embodiment, lid 12 is comprised of a first piece 22 and a second piece 24 that are substantially the same in both size and shape, and that are configured to be separably coupled together. However, it should be noted that in one alternate preferred embodiment, lid 12 is of a singular, one-piece construction. Accordingly, such constructions having more or less than two pieces remain within the spirit and scope of the present invention.

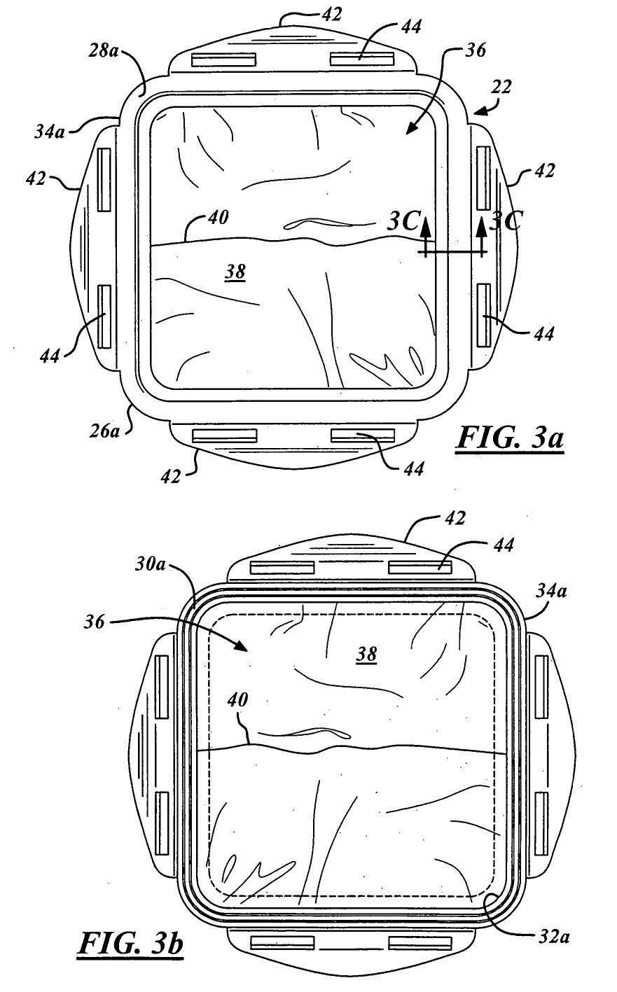

With reference to FIGS. 2-5, first and second pieces 22, 24 each provide an outer frame 26a and 26b, respectively, with an open center. Each of frames 26a, 26b include a respective top surface 28a, 28b, a respective bottom surface 30a, 30b opposite top surface 28a, 28b, a respective inner surface 32a, 32b, and a respective outer surface 34a, 34b opposite inner surface 32a, 32b. Frames 26a, 26b may be of a variety of shapes and sizes, depending on the application in which container 10 is to be used, and may be formed of any number of materials, such as, for example, metal, plastic, wood and other like materials. In one preferred embodiment, frames 26a, 26b are in the shape of a square and are made of plastic. The coupling of outer frames 26a, 26b aligns the respective openings therein and defines an opening 36. With reference to FIG. 3a, within opening 36 provided by frames 26a, 26b, a flexible portion 38 is disposed, thereby covering the defined opening 36. Flexible portion 38 includes at least one slit 40 that, once first and second pieces 22, 24 of lid 12 are coupled together with receptacle 14, allows for the depositing and removal of items into and from receptacle 14 through slit 40. Flexible portion 38 may be disposed within the openings of either frame 26a, 26b. In one preferred embodiment, however, it is disposed within frame 26a.

Flexible portion 38 of lid 12 may be made of a flexible, elastic material, such as latex, however, any other flexible material having similar characteristics, such as plastic, for example, may be used. Flexible portion 38 is secured within the outer frame 26a by a fastening means, which may include, but is not limited to, the use of an adhesive, such as, for example purposes only, glue and other like substances. In one embodiment, flexible portion 38 may be provided by two separate pieces that overlap each other, wherein one piece may be tucked within the other so as to provide slit 40 in a flap-like configuration. In an alternate embodiment, flexible portion 38 is an unitary piece wherein slit 40 bi-sects flexible portion 38. Slit 40 may extend the entire expanse of flexible portion 38, or may be of a lesser length. Additionally, in one alternate preferred embodiment, flexible portion 38 may have a pair of slits formed in flexible portion 38 that are situated perpendicular to and bi-sect each other so as to form a cross. In any of the aforementioned embodiments, access into cavity 20 of receptacle 14 is provided through the entering of slit 40. Moreover, alternate embodiments may be used which provide access to the receptacle through the use of a flexible portion in the lid, while still providing an anti-spill characteristic.

With continued reference to FIGS. 3a-6, various attachment and securing means may be used for coupling first and second pieces 22, 24 of lid 12 together. Such means may include, but are not limited to, snap-fit attachment mechanisms, hook and loop attachment mechanisms, latching mechanisms, or any other attachment mechanism known in the art. In the embodiment illustrated in FIGS. 3a-3c, first piece 22 includes a plurality of flanges 42 hingeably coupled to outer surface 34a of frame 26a, for example, in accordance with known hinging arrangements (best shown in FIG. 3c). As shown in FIG. 3a, first piece 22 is in the shape of a square and includes a flange 42 on each side thereof for a total of four flanges. It should be noted, however, that although four flanges are shown, various numbers of flanges can be used depending on the shape and size of frame 26a. Flanges 42 are provided to aid in the attachment of first piece 22 to second piece 24 to create lid 12, as well as in the attachment of receptacle 14 to lid 12.

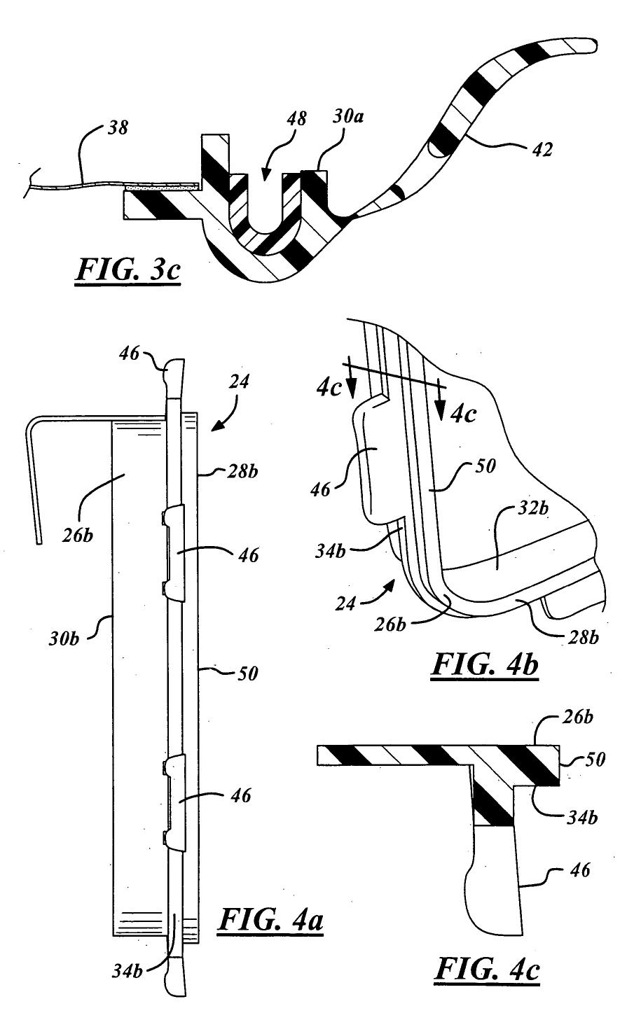

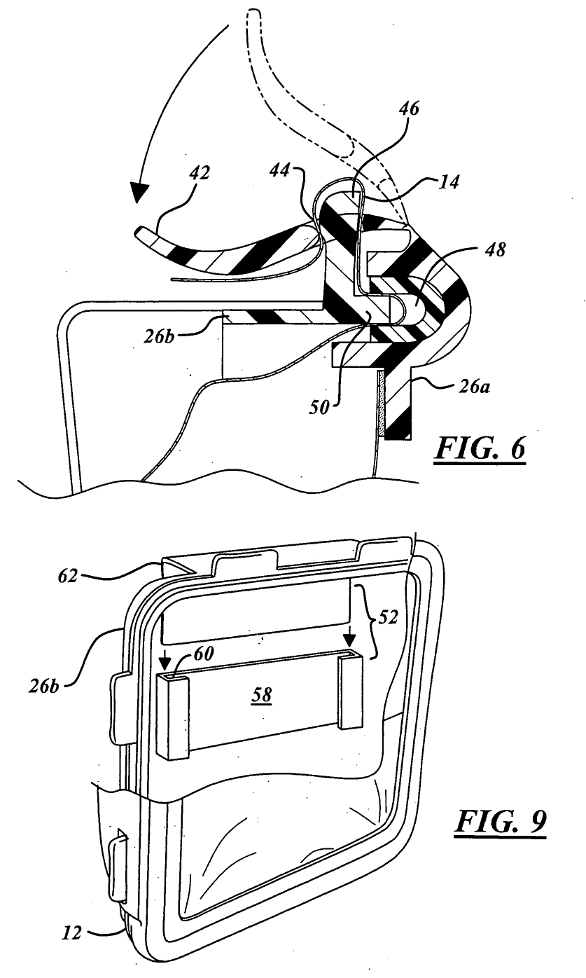

Each flange 42 further includes a plurality of slots 44 for receiving and retaining corresponding tabs 46 of second piece 24. As illustrated in FIGS. 4a-4c, second piece 24 includes at least one, but preferably a plurality, of tabs 46 protruding from the outer surface 34b of frame 26b. Tabs 46 are configured in both size and shape to be complimentary with slots 44 in corresponding flanges 42. As shown in FIG. 6, tabs 46 of second piece 24 are configured such that they are insertable within slots 44 as flanges 42 are snapped down to secure first and second pieces 22, 24 together. Accordingly, upon the snapping of flanges 42 over the respective tabs 46, flanges 42 rigidly couple first and second pieces 22, 24 of lid 12 together. In the illustrated embodiment, second piece 24 is formed in the shape of a square and includes a pair of spaced apart tabs 46 on each side. Accordingly, each flange 42 also has a pair of slots 44 therein for receiving tabs 46. It should be noted, however, that embodiments having a greater or lesser number of tabs 46 and corresponding slots 44 remain within the spirit and scope of the present invention. Additionally, the size and number of the lid components may be varied depending on the design and need of the container. Accordingly, various configurations, numbers and configurations of the lid components may be used, and the provided dimensions on the drawings are in no way intended to limit the invention.

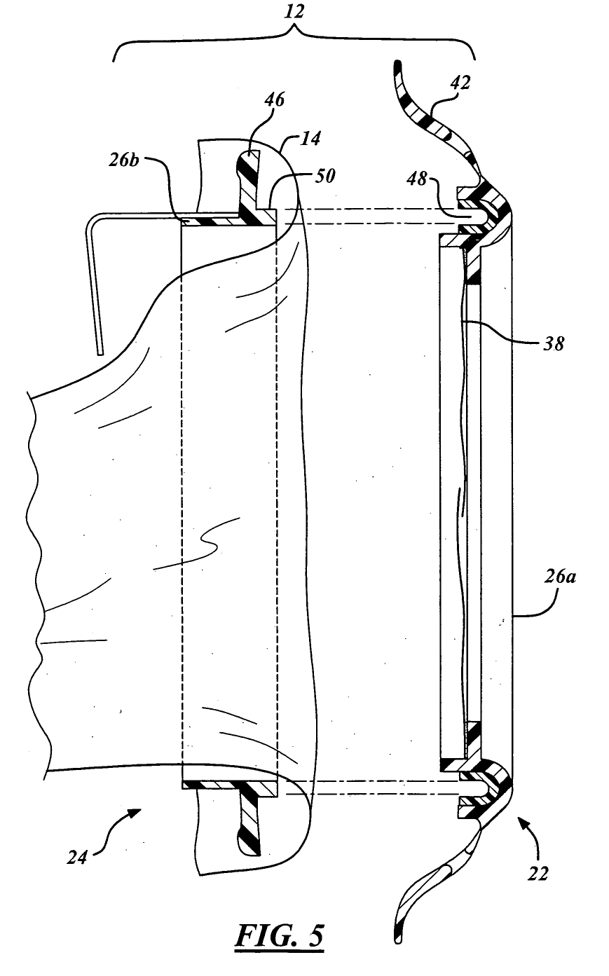

With particular reference to FIGS. 3c, 5 and 6, in addition to flanges 42 of first piece 22, a groove 48 is provided on the bottom surface 30a of frame 26a extending around the perimeter of bottom surface 30a. A cross sectional view of groove 48 is shown in FIG. 3c. Groove 48 is configured to receive a lip 50 (best shown in FIGS. 4a-4c) protruding from and extending around the perimeter of the top surface 28b of frame 26b of second piece 24. Lip 50 is complimentary with groove 48 of first piece 22 in that it reflects the size and design of groove 48 and is configured to be inserted into and received by groove 48. With reference to FIGS. 5 and 6, upon insertion of lip portion 42 into groove 48, first and second pieces 22, 24 are placed in alignment.

Referring now to FIGS. 5-7, in practice, lid 12 and receptacle 14 are assembled as follows. The upper portion of receptacle 14 at open end 16 is fed up and through the opening in the center of second piece 24. The edges of the upper portion are the placed over frame 26b such that the edges are generally folded over the perimeter of frame 26b, including lip 50 (see FIG. 6). First piece 22 is then aligned with second piece 24 such that groove 48 in first piece 22 is aligned with lip 50 of second piece 24. First and second pieces 22, 24 are then compressed together so as to cause lip 50 to be inserted into groove 48. This causes the upper portion of receptacle 14 to be captured in between pieces 22, 24. Flanges 42 are then snapped over tabs 46, so as to securely couple first and second pieces 22, 24 together (see FIGS. 6 and 7). Flanges 42 also ensure that receptacle 14 is securely captured and retained in place as the portions of receptacle 14 that are folded over tabs 46 are inserted with tabs 46 into slots 44 of flanges 42. Accordingly, receptacle 14 cannot be removed from lid 12 unless flanges 42 are unsnapped.

In one preferred embodiment, inventive container 10 further includes a mounting mechanism 52 configured to allow for container 10 to be removably mounted to any number of surfaces or things. Mounting mechanism 52 may be comprised of, but is not limited to, a hook and loop assembly, an integrated tab, a mounting plate, velcro, or any combination thereof; as well as other mounting means known in the art.

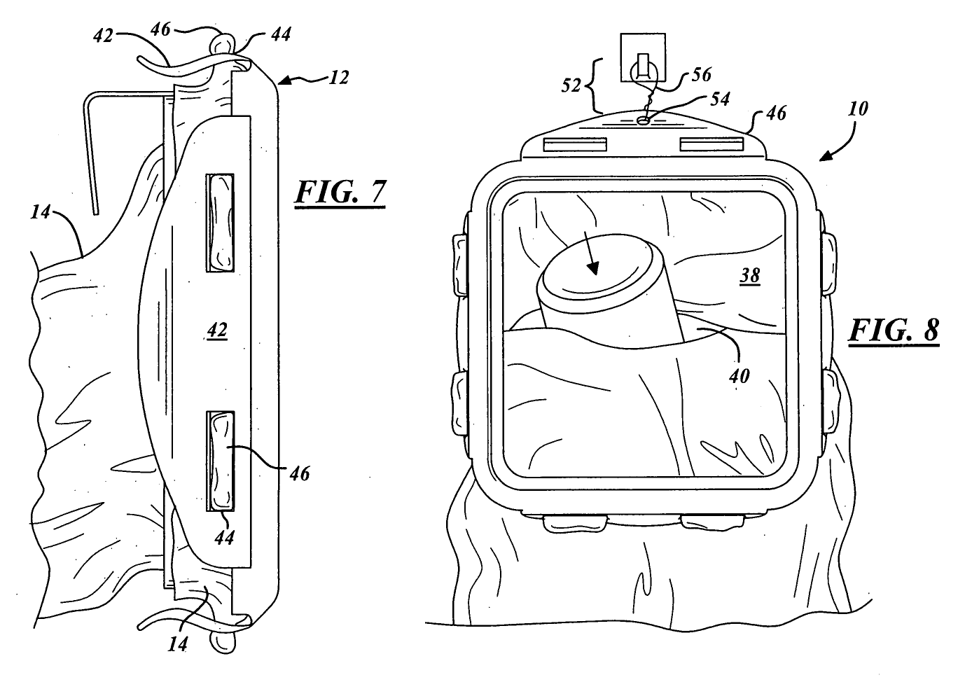

In one preferred embodiment shown in FIG. 8, mounting mechanism 52 is comprised of an aperture 54 in lid 12 and an attachment member 56. In the illustrated embodiment, Aperture 54 is provided in one of flanges 42 of first piece 22. However, aperture 54 may be provided in either first or second pieces 22, 24 of lid 12. Aperture 54 is provided to allow attachment member 56 to be threaded therethrough. Attachment member 56 may include, but is not limited to, for example, a piece of string, a rubber band, a wire, or any other like material. The combination of attachment member 56 and aperture 54 allows container 10 to be hung from a particular surface, which may include, but is not limited to, a fence, door knob, hook, etc. In the illustrated embodiment, container 10 is hung on a hook that is mounted to a wall.

In one alternate preferred embodiment illustrated in FIG. 9, mounting mechanism 52 comprises a mounting plate 58 having a slot 60 therein. Mounting plate 58 may be permanently or removeably affixed to a surface (i.e., a wall, a dashboad, etc.) in any number of ways, such as, for example, by adhesive or mechanical fasteners. Mounting mechanism 52 further includes a corresponding tongue 62 formed as an integral part of, or separably affixed to, either one of first and second pieces 22, 24 of lid 12. In the illustrated embodiment, tongue 62 is an integral part of and protrudes from second piece 24, and is configured to be inserted into and retained within slot 60 of mounting plate 58. This configuration allows for the removable mounting of the container to the surface to which mounting plate 58 is affixed.

The aforementioned embodiments are merely examples of various mounting means that may be provided to mount and secure container 10. The embodiments are in no way meant to limit the scope of the invention and those skilled in the art will recognize and appreciate that other viable mounting means exist that remain within the spirit and scope of the present invention.

Once container 10 is mounted, it may be used for the disposal of refuse. The refuse inserted into container 10 through slit 40 and is received within cavity 20 of receptacle 14. As the refuse is inserted, slit 40 is opened to receive the item (see FIG. 8). Following the deposit of the item within receptacle 14, flexible portion 38 providing slit 40 returns to its original closed position. Once receptacle 14 is filled or otherwise needs to be emptied or replaced, flanges 42 are lifted and unsnapped, allowing first and second pieces 22, 24 of lid 12 to be separated, thereby allowing receptacle 14 to be decoupled and removed from lid 12. Receptacle 14 can then be replaced or re-assembled with lid 12 by following the assembly process set forth above.

Although the present invention is provided for the use of receiving refuse, the anti-spill container is not so limited and may be used to retain various other items, such as, for example, food items, office supplies, household items, and the like. While only those embodiments set forth above have been described in detail, other configurations and embodiments for the present invention exist that are within the spirit and scope of the invention.

1. An anti-spill container comprising:
a receptacle having an open end and a closed end, wherein said open end and closed end define a cavity;
a lid detachably coupled to said receptacle, wherein said lid comprises a frame having an opening therein and a flexible portion disposed within said opening, wherein said flexible portion is provided with at least one slit therein, thereby providing access to said cavity provided by said receptacle; and
a mounting mechanism operative to mount said container on a surface.

2. The anti-spill container in accordance with claim 1 wherein said receptacle is disposable.

3. The anti-spill container in accordance with claim 1 wherein said receptacle is a bag.

4. The anti-spill container in accordance with claim 1 wherein said lid comprises:
a first piece comprising a frame, said frame having a top surface, a bottom surface opposite said top surface, an outer surface and an inner surface opposite said outer surface, and an opening therein; and
a second piece substantially the same size and shape of said first piece and comprising a frame, said frame having a top side, a bottom side opposite said top side, an outer surface and an inner surface opposite said outer surface, and an opening therein, said second piece separably coupled to said first piece;
wherein a portion of said receptacle proximate said open end is captured between said first and second pieces when said first and second pieces are coupled together.

5. The anti-spill container in accordance with claim 4 wherein said flexible portion is disposed within said opening in said frame of said first piece of said lid.

6. The anti-spill container in accordance with claim 4 wherein:
said first piece comprising at least one flange hingeably coupled to said frame thereof, said at least one flange having at least one slot therein;
said second piece comprising at least one tab protruding from said outer surface of said frame, said at least one tab being positioned and sized so as to be complimentary with and insertable within said at least one slot in said flange;
said at least one flange operative to snap over said at least one tab such that said at least one tab is received by and retained within said at least one slot, thereby coupling said first and second pieces together.

7. The anti-spill container in accordance with claim 6 wherein:
said first piece includes a groove disposed within the bottom surface of said frame;
said second piece includes a lip protruding from the top surface of said frame;
said groove configured to receive and retain said lip therein when said first and second pieces are coupled together.

8. The anti-spill container in accordance with claim 4 wherein:
said first piece includes a groove disposed within the bottom surface of said frame;
said second piece includes a lip protruding from the top surface of said frame;
said groove configured to receive and retain said lip therein when said first and second pieces are coupled together.

9. The anti-spill container in accordance with claim 1 wherein said flexible portion is made of latex.

10. The anti-spill container in accordance with claim 1 wherein said flexible portion is formed of a first and a second piece, said first and second pieces overlapping each other such that a portion of one of said first and second pieces is tucked under a portion of the other so as to form a slit therein.

11. The anti-spill container in accordance with claim 1 wherein said flexible portion is affixed to said lid with an adhesive.

12. The anti-spill container in accordance with claim 1 wherein said mounting mechanism comprises:
an aperture in said lid; and
an attachment member operative to be inserted through said aperture and affixed to said surface.

13. The anti-spill container in accordance with claim 1 wherein said mounting mechanism comprises:
a tongue protruding from said lid; and
a mounting plate having a slot therein to receive and retain said tongue, said mounting plate being mountable on said surface.

14. An anti-spill container comprising:
a receptacle having an open end and a closed end, wherein said open end and closed end define a cavity;
a lid detachably coupled to said receptacle, said lid comprising:
a first piece including a frame, said frame having a top surface, a bottom surface opposite said top surface, an outer surface, an inner surface opposite said outer surface, and an opening therein; and
a second piece substantially the same size and shape of said first piece, said second piece including a frame, said frame having a top surface, a bottom surface opposite said top surface, an outer surface, an inner surface opposite said outer surface, and an opening therein, said second piece separably coupled to said first piece;
wherein a portion of said receptacle proximate said open end is captured between said first and second pieces when said first and second pieces are coupled together;
and further wherein said lid comprises a flexible portion disposed within one of said openings in said frames of said first and second pieces, wherein said flexible portion is provided with at least one slit therein, thereby providing access to said cavity provided by said receptacle; and
a mounting mechanism operative to mount said container to a surface.

15. The anti-spill container in accordance with claim 14 wherein said receptacle is a disposable bag.

16. The anti-spill container in accordance with claim 14 wherein:
said first piece comprises at least one flange hingeably coupled to said frame thereof, said at least one flange having at least one slot therein;
said second piece comprises at least one tab protruding from said outer surface of said frame, said at least one tab being positioned and sized so as to be complimentary with and insertable within said at least one slot in said flange;
said at least one flange operative to snap over said at least one tab such that said at least one tab is received by and retained within said at least one slot, thereby coupling said first and second pieces together.

17. The anti-spill container in accordance with claim 16 wherein:
said first piece includes a groove disposed within the bottom surface of said frame;
said second piece includes a lip protruding from the top surface of said frame;
said groove configured to receive and retain said lip therein when said first and second pieces are coupled together.

18. The anti-spill container in accordance with claim 14 wherein said receptacle is disposable.

19. An anti-spill refuse container comprising:
a receptacle having an open end and a closed end, wherein said open end and closed end define a cavity;
a lid that is detachably coupled to said receptacle, wherein said lid comprising:
a first piece including a frame, said frame having a top surface, a bottom surface opposite said top surface, an outer surface and an inner surface opposite said outer surface, and an opening therein; and
a second piece substantially the same size and shape of said first piece and comprising a frame, said frame having a top surface, a bottom surface opposite said top surface, an outer surface and an inner surface opposite said outer surface, and an opening therein, said second piece separably coupled to said first piece;
said first piece comprising at least one flange hingeably coupled to said frame thereof, said at least one flange having at least one slot therein;
said second piece comprising at least one tab protruding from said outer surface of said frame, said at least one tab being positioned and sized so as to be complimentary with and insertable within said at least one slot in said flange;
said at least one flange operative to snap over said at least one tab such that said at least one tab is received by and retained within said at least one slot, thereby coupling said first and second pieces together,
wherein a portion of said receptacle proximate said open end is captured between said first piece and said second piece when said first and second pieces are coupled together;
and further wherein said lid comprises a flexible portion disposed within said opening in said frame of said first piece, wherein said flexible portion is provided with at least one slit therein, thereby providing access to said cavity provided by said receptacle; and
a mounting mechanism operative to mount said container to a surface.

20. The anti-spill refuse container in accordance with claim 19 wherein said receptacle is a disposable bag.
